(19) United States
(12) Patent Application Publication
(10) Pub. No.: US 2023/0418253 A1
(43) Pub. Date: Dec. 28, 2023

(54) INPUT/OUTPUT MODULE AND CONTROL SYSTEM

(71) Applicant: Mitsubishi Electric Corporation, Tokyo (JP)

(72) Inventor: Hirofumi AKIBA, Tokyo (JP)

(73) Assignee: Mitsubishi Electric Corporation, Tokyo (JP)

(21) Appl. No.: 18/036,172

(22) PCT Filed: May 6, 2021
(86) PCT No.: PCT/JP2021/017387

§ 371 Date: May 10, 2023

(51) Int. Cl. G05B 19/042; G05B 19/418

(52) U.S. Cl. CPC G05B 19/0423; G05B 19/0428; G05B 19/4185

(57) ABSTRACT

An I/O module includes an input terminal and an output terminal, receives from a host controller first setting information for setting a condition of a value of a signal to be output from the output terminal or a condition between a value of an input signal received by the input terminal and a value of the signal to be output from the output terminal, receives second setting information, controls switching of a mode, and causes, based on the first setting information when the mode is in a first mode and based on the second setting information when the mode is in a second mode, the output terminal to output a signal with the set value or with a value in accordance with the set condition and the value of the input signal received by the input terminal.

### TECHNICAL FIELD

The present disclosure relates to an input-output module and a control system.

### BACKGROUND ART

Devices for automating production processes are used at factories. A control system including a programmable logic controller (PLC) is used to control such devices.

An input-output (I/O) module included in the PLC acquires input-output information for controlling devices from a host controller connected through a network and provides signals or electric power to the devices.

Patent Literatures 1 and 2 each describe an I/O module connected to a central processing unit (CPU) module to operate as a host controller for setting the I/O module.

### CITATION LIST

### Patent Literature

Patent Literature 1: Unexamined Japanese Patent Application Publication No. 2008-251052
Patent Literature 2: Unexamined Japanese Patent Application Publication No. 03-222010

### SUMMARY OF INVENTION

### Technical Problem

Such I/O modules operate in accordance with the settings of the host controller connected to the modules. Before the host controller is connected to the modules, the I/O modules cannot start operating, or the startup operation of a control system cannot be performed.

The I/O modules described in Patent Literatures 1 and 2 each include a circuit for causing, when the host controller stops operating, a device subsequent to the host controller to continue the output. The I/O modules described in Patent Literatures 1 and 2 operate when connected to a host controller. Before being connected to the host controller, these I/O modules cannot provide electric power or signals to external devices connected to the I/O modules.

A known I/O module cannot perform the startup operation of a control system or examine the operation of an external device connected to the I/O module before the I/O module is connected to a host controller.

In response to the above issue, an objective of the present disclosure is to provide an I/O module and a control system that can perform the startup operation of a control system and can examine the operation of an external device connected to the I/O module before the I/O module is connected to a host controller.

### Solution to Problem

To achieve the above objective, an input-output module according to an aspect of the present disclosure includes an inputter including an input terminal to receive an input signal, an outputter including an output terminal to output a signal, a communicator to receive first setting information from a host controller, the first setting information being information for setting a condition of a value of the signal to be output from the output terminal or a condition between a value of the input signal received by the input terminal and a value of the signal to be output from the output terminal, a setting receiver to receive second setting information, the second setting information being information for setting the condition of the value of the signal to be output from the output terminal or the condition between the value of the input signal received by the input terminal and the value of the signal to be output from the output terminal, a setting storage to store the first setting information received by the communicator or the second setting information received by the setting receiver, and an input-output controller to, based on the first setting information or the second setting information stored in the setting storage, cause the output terminal to output a signal with the set value or cause the output terminal to output a signal with a value in accordance with the set condition and the value of the input signal received by the input terminal.

### Advantageous Effects of Invention

The I/O module and the control system according to the above aspect of the present disclosure can perform the startup operation of a control system and can examine the operation of an external device connected to the I/O module before the I/O module is connected to a host controller.

### BRIEF DESCRIPTION OF DRAWINGS

FIG. 1 is a diagram of a control system according to Embodiment 1 of the present disclosure illustrating an overall configuration;

FIG. 2 is a diagram describing the details of an inputter and an outputter in an I/O module included in the control system illustrated in FIG. 1;

FIG. 3 is a table of specific example information stored in a setting storage in the I/O module included in the control system illustrated in FIG. 1;

FIG. 4 is a diagram of example signals to be output from the I/O module included in the control system illustrated in FIG. 1;

FIG. 5 is a diagram of other example signals to be output from the I/O module included in the control system illustrated in FIG. 1;

FIG. 6 is a diagram of other example signals to be output from the I/O module included in the control system illustrated in FIG. 1;

FIG. 7 is a diagram of other example signals to be output from the I/O module included in the control system illustrated in FIG. 1;

FIG. 8 is a diagram of other example signals to be output from the I/O module included in the control system illustrated in FIG. 1;

FIG. 9 is a diagram of other example signals to be output from the I/O module included in the control system illustrated in FIG. 1;

FIG. 10 is a block diagram of the I/O module included in the control system illustrated in FIG. 1 illustrating a specific example hardware configuration;

FIG. 11 is a diagram of a control system according to Embodiment 2 illustrating an overall structure;

FIG. 12 is a table of example information that appears on a display included in the control system illustrated in FIG. 11;

FIG. 13 is a diagram of a control system according to Modification 1 illustrating an overall configuration; and

FIG. 14 is a diagram of a control system according to Modification 2 illustrating an overall configuration.

### DESCRIPTION OF EMBODIMENTS

### Embodiment 1

A control system 1 functioning as a programmable logic controller (PLC) including an input-output (I/O) module 300 according to Embodiment 1 of the present disclosure is described below with reference to the drawings.

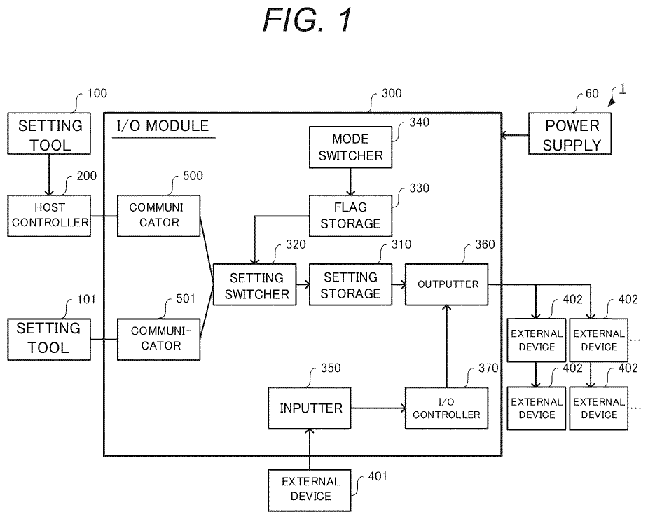

Overview of Control System 1 The control system 1 illustrated in FIG. 1 includes an I/O module 300, a host controller 200 that outputs signals for controlling the I/O module 300, and a power supply that provides electric power to the I/O module 300.

External devices 401 and 402 are connected to the I/O module 300.

Setting Tools 100 and 101

Setting tools 100 and 101 are connected to the I/O module 300. The setting tools 100 and 101 set setting information about signals input from the external device 401 and signals to be output to the external devices 402, as described in detail later.

Examples of the setting tools 100 and 101 include a personal computer (PC), a smartphone, and a tablet terminal in each of which application software is installed.

The setting tool 100 is connected to the I/O module 300 with the host controller 200 in between. The setting tool 101 is directly connected to the I/O module 300 without the host controller 200 in between.

Host Controller 200

The host controller 200 acquires, from the setting tool 100, setting information to be set with the I/O module 300.

The host controller 200 may execute a program created by a user and generate setting information to be set with the I/O module 300 based on the execution result.

Structure of I/O Module 300

The I/O module 300 includes a communicator 500 that communicates with the connected host controller 200. The I/O module 300 acquires setting information set by the setting tool 100 through the host controller 200.

The I/O module 300 also includes a communicator 501 that directly communicates with the setting tool 101. The I/O module 300 acquires setting information set by the setting tool 101.

The communicator 501 is an example of a communication interface or a setting receiver. The setting information is an example of first setting information or second setting information. The setting tool 101 is an example of a setting terminal.

Details of I/O Module 300

The I/O module 300 includes a setting storage 310 that stores setting information about an input and an output received by the communicator 500 or the communicator 501, a setting switcher 320 that switches the setting information stored in the setting storage 310 between setting information received through the communicator 500 and setting information received through the communicator 501, a mode switcher 340 that switches a startup determination mode (described later), a flag storage 330 that stores a flag value for a startup determination corresponding to the startup determination mode. The I/O module 300 further includes an inputter 350 that receives a signal input from the external device 401 connected to the I/O module 300, an outputter 360 that outputs signals to the external devices 402 connected to the I/O module 300, and an input-output (I/O) controller 370 that controls the value of the signal to be output from the outputter 360 based on the setting information stored in the setting storage 310.

Startup Determination Mode and Startup Determination Flag

The startup determination mode is either of a startup mode indicating the control system 1 in a startup operation, or a non-startup mode indicating the control system 1 in a state other than the startup operation. The mode switcher 340 switches the value of the startup determination mode between the startup mode and the non-startup mode.

The startup determination flag corresponds to the startup determination mode. The startup determination flag is set on when the startup determination mode is in the startup mode and is set off when the startup determination mode is in the non-startup mode. The flag storage 330 stores the flag value for the startup determination indicating either on or off

Inputter 350 and Outputter 360

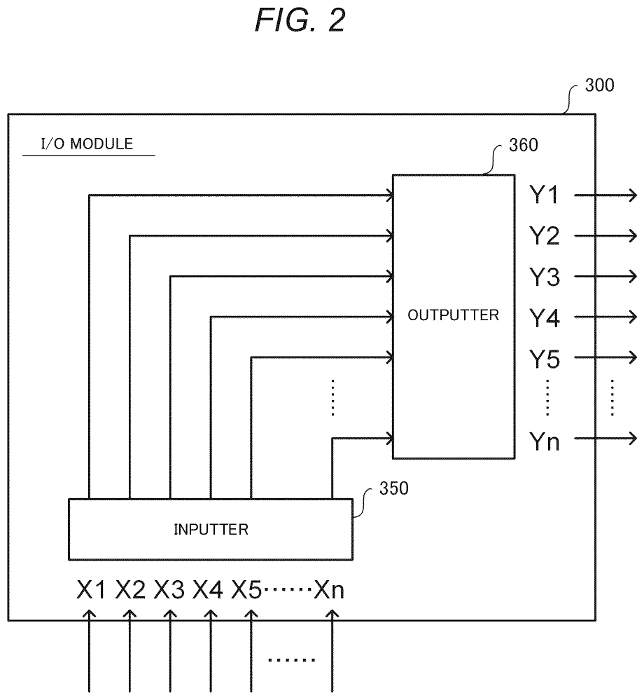

In FIG. 2, the inputter 350 includes n input terminals X1, X2, . . . , Xn, and the outputter 360 includes n output terminals Y1, Y2, . . . , Yn.

The values of signals output from the output terminals Y1, Y2, . . . , Yn are controlled by the I/O controller 370 based on the setting information stored in the setting storage 310.

Although the input terminals X1, X2, . . . , Xn correspond one-to-one to the output terminals Y1, Y2, . . . , Yn in FIG. 2, the input terminals X1, X2, . . . , Xn and the output terminals Y1, Y2, . . . , Yn may not be in one-to-one correspondence with one another.

The setting information includes information for setting the values of signals to be output from the output terminals Y1, Y2, . . . , Yn, or information for setting the condition between the values of signals input into the input terminals X1, X2, . . . , Xn and the values of signals to be output from the output terminals Y1, Y2, . . . , Yn. The condition may be unrelated to the values of signals input into the input terminals X1, X2, . . . , Xn. The condition may be, for example, an operation result of a program. The I/O module 300 may acquire an operation result of a program executed by the host controller 200 and output the operation result to the output terminals Y1, Y2, . . . , Yn.

I/O Controller 370

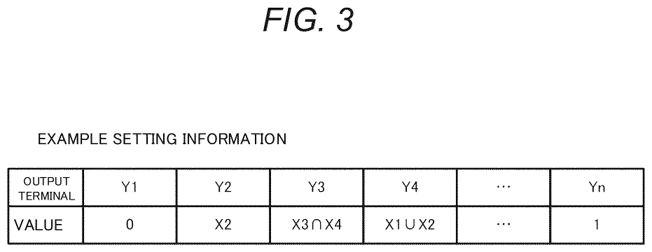

FIG. 3 illustrates example setting information. The I/O controller 370 causes, based on the setting information, the output terminal Y1 to output a signal with a value of 0, the output terminal Y2 to output a signal with the same value as the value of the signal input into the input terminal X2, and the output terminal Yn to output a signal with a value of 1. The I/O controller 370 causes, based on the setting information, the output terminal Y3 to output a signal with a value expressed using logical AND of the value of the signal input into the input terminal X3 and the value of the signal input into the input terminal X4. The I/O controller 370 causes, based on the setting information, the output terminal Y4 to output a signal with a value expressed using logical OR of the value of the signal input into the input terminal X1 and the value of the signal input into the input terminal X2.

Referring back to FIG. 1, the mode switcher 340 is, for example, a toggle switch, a push button switch, or a dual in-line package (DIP) switch. The mode switcher 340 is not limited to a mechanical switch. For example, the mode switcher 340 may be an electrical or electronic switch that detects any connection of the host controller 200 and then switches the startup determination mode from the startup mode to the non-startup mode.

The startup determination modes switchable by the mode switcher 340 includes the startup mode that is an example of a first mode and the non-startup mode that is an example of a second mode.

The setting switcher 320 switches, based on the startup determination mode switched by the mode switcher 340, the setting information to be stored in the setting storage 310 between the setting information received through the communicator 501 from the host controller 200 and the setting information received through the communicator 501.

More specifically, the setting switcher 320 stores the setting information received through the communicator 501 from the setting tool 101 into the setting storage 310 when the flag stored in the flag storage 330 is on. The setting switcher 320 stores the setting information received through the communicator 500 from the host controller 200 into the setting storage 310 when the flag stored in the flag storage 330 is off

The setting storage 310 stores a single piece of setting information at a time. Thus, when the communicator 500 receives setting information from the host controller 200, the setting storage 310 overwrites the setting information received through the communicator 501 and stored in the setting storage 310 with, for example, the setting information newly received through the communicator 500 from the host controller 200.

The I/O controller 370 changes the values of the signal to be output from the outputter 360 based on the setting information stored in the setting storage 310 or the value of the signal input into the inputter 350.

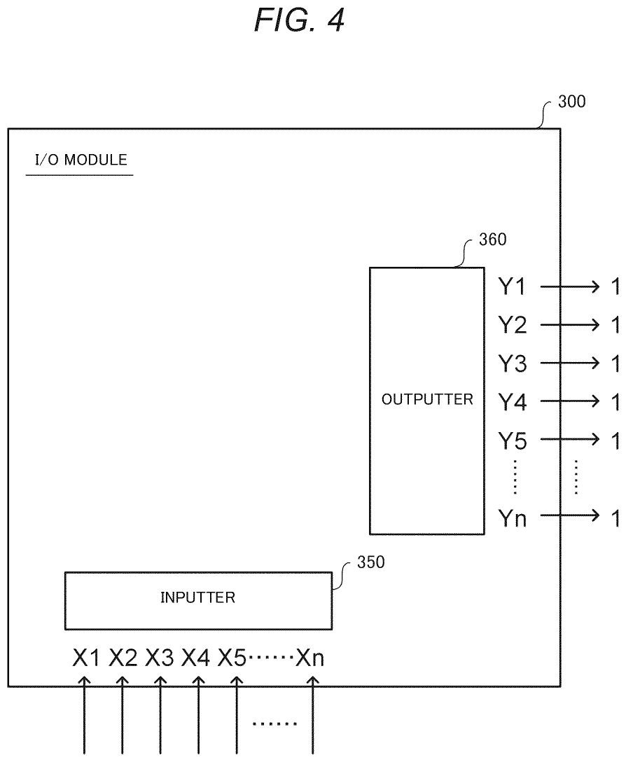

The value of the signal input into each of the input terminals X1, X2, . . . , Xn in the inputter 350 and the value of the signal to be output from each of the output terminals Y1, Y2, . . . , Yn in the outputter 360 are described below with reference to FIGS. 4 to 9.

In the example illustrated in FIG. 4, independently of the value of the signal input into each of the input terminals X1, X2, . . . , Xn in the inputter 350, the I/O controller 370 causes each of all the output terminals Y1, Y2, . . . , Yn in the outputter 360 to output a signal with a value of 1. When an external device 402 operates upon receiving a signal with a value of 1, the operation of the external device 402 connected to the outputter 360 can be examined without the external device 401 being connected to the inputter 350 at the startup of the control system 1.

In another example, the I/O controller 370 performs control described below depending on whether the values of the signals input into the input terminals X1, X2, . . . , Xn in the inputter 350 are all 1 indicating being on.

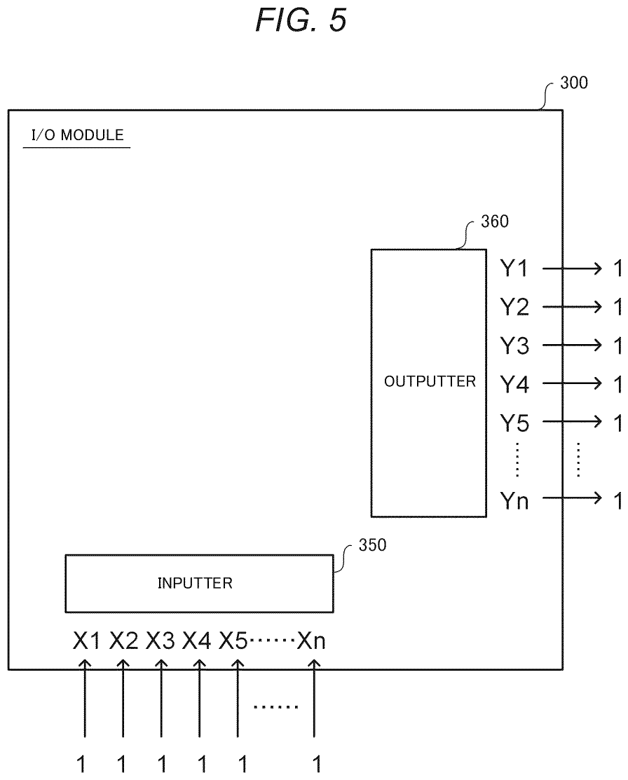

As illustrated in FIG. 5, when the values of the signals input into the input terminals X1, X2, . . . , Xn in the inputter 350 are all 1, the I/O controller 370 causes each of all the output terminals Y1, Y2, . . . , Yn in the outputter 360 to output a signal with a value of 1.

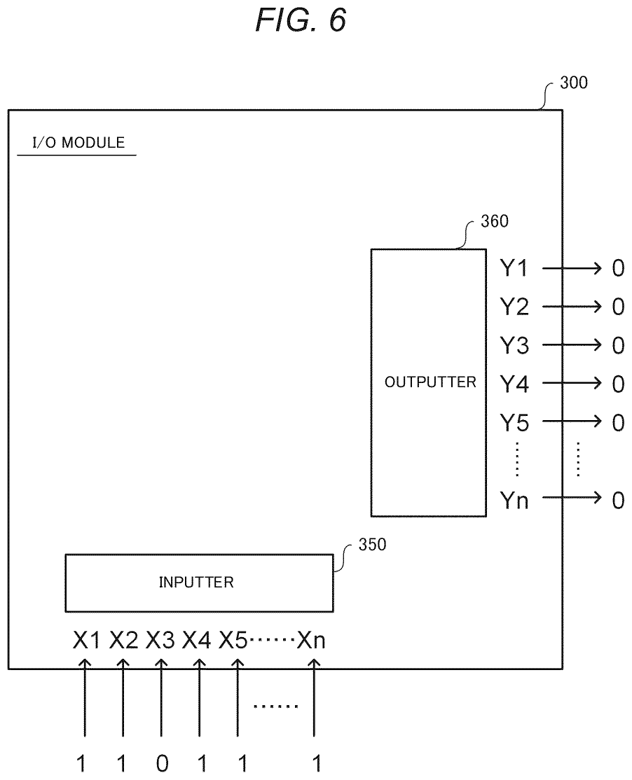

As illustrated in FIG. 6, when the value of at least one of the signals input into the input terminals X1, X2, . . . , Xn in the inputter 350 is 0, the I/O controller 370 causes each of all the output terminals Y1, Y2, . . . , Yn in the outputter 360 to output a signal with a value of 0.

Under this control, the I/O module 300 allows detection of any abnormality to stop power in the control system 1.

The external device 401 connected to the inputter 350 is a safety switch to allow a signal with a value of 0 to be output when any abnormality is detected.

As illustrated in FIG. 5, when none of the sensors and safety switches detects an abnormality, each of all the input terminals X1, X2, . . . , Xn receives an input signal with a value of 1. The I/O controller 370 thus causes each of all the output terminals Y1, Y2, . . . , Yn to output a signal with a value of 1.

When at least one safety switch detects an abnormality, for example, when the safety switch connected to the input terminal X3 (illustrated in FIG. 6) detects an abnormality and a signal with a value of 0 is input into the input terminal X3, the I/O controller 370 causes each of all the output terminals Y1, Y2, . . . , Yn to output a signal with a value of 0.

The control system 1 with this structure causes each of all the output terminals Y1, Y2, . . . , Yn to output a signal with a value of 0 when any safety switch detects an abnormality. Each external device 402 connected to the outputter 360 can detect a signal with a value of 0 and stop operating. Thus, the external devices 402 can be stopped safely.

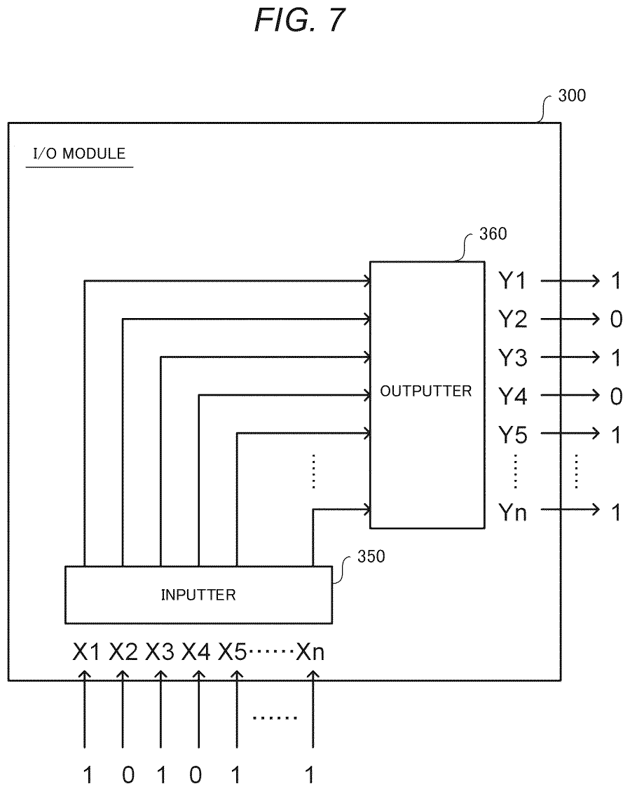

In still another example, as illustrated in FIG. 7, the I/O controller 370 causes each of the output terminals Y1, Y2, . . . , Yn in the outputter 360 to output a signal corresponding to the value of a signal input into each of the input terminals X1, X2, . . . , Xn in the inputter 350 without changing the value of the signal.

An input device as the external device 401 is connected to the inputter 350. This structure allows the input device to directly control the external devices 402 connected to the outputter 360, with the I/O module 300 being connected between the input device and the external devices 402.

In another example, the I/O controller 370 controls the output based on the value of the signal input into the input terminal X1 as a control input terminal selected from the input terminals X1, X2, . . . , Xn in the inputter 350.

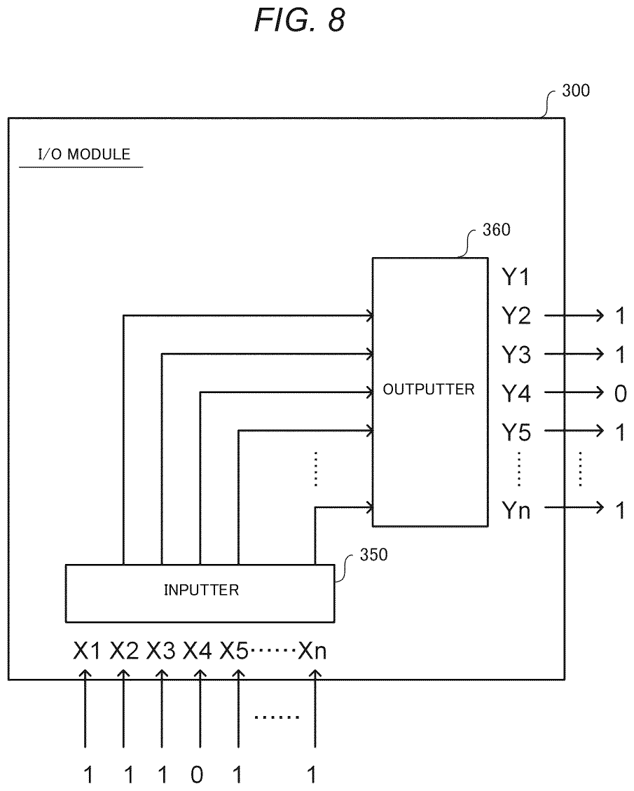

When the input terminal X1 receives an input signal with a value of 1 as in the example illustrated in FIG. 8, the I/O controller 370 causes each of the output terminals Y2, Y3, . . . , Yn in the outputter 360 corresponding to the input terminals in the inputter 350 to output the corresponding signal without changing the value of the signal input into each of the input terminals X2, X3, . . . , Xn except the input terminal X1 in the inputter 350.

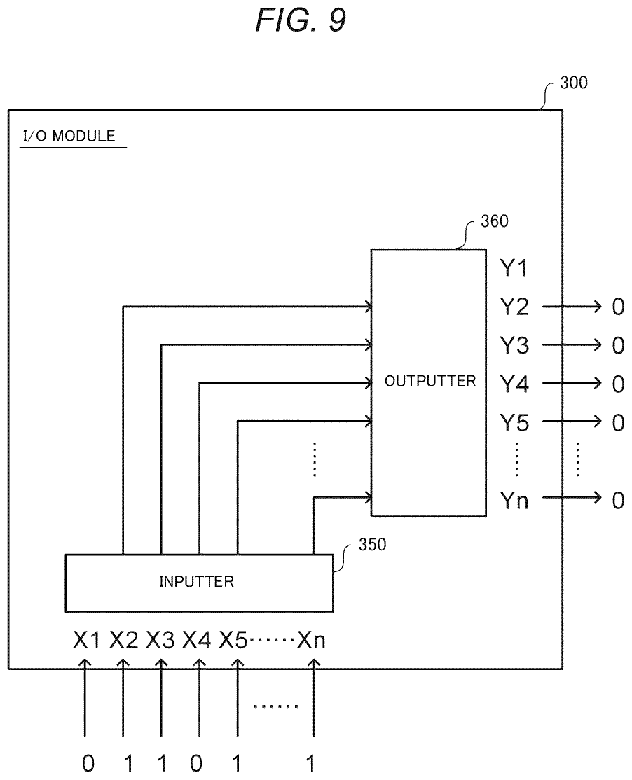

In contrast, when the input terminal X1 selected as a control input terminal receives an input signal with a value of 0 as in the example illustrated in FIG. 9, the I/O controller 370 causes each of all the output terminals Y2, Y3, . . . , Yn except the output terminal Y1 in the outputter 360 to output a signal with a value of 0.

This control allows both a safe stop of the external devices through the input terminal X1 selected as a control input terminal and a control of the external devices 402 through the input terminals X2, X3, . . . , Xn except the input terminal X1 selected as a control input terminal.

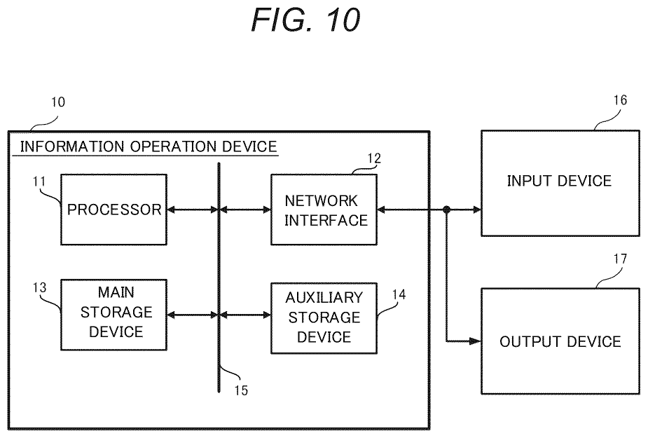

The I/O module 300 described above can be implemented by an information operation device 10 with, for example, the hardware configuration illustrated in FIG. 10.

The information operation device 10 includes a processor 11 that performs various arithmetic operations, a network interface (IF) 12 that communicates with other devices including an input device 16 and an output device 17, a main storage device 13 that temporarily stores information, such as a dynamic random-access memory (DRAM) or a static random-access memory (SRAM), an auxiliary storage device 14 that permanently stores information, such as a hard disk drive (HDD) or a solid-state drive (SSD), and a bus 15 as a path for information exchanged between the processor 11, the network interface 12, the main storage device 13, and the auxiliary storage device 14.

The processor 11 is an example of hardware that implements the setting switcher 320, the I/O controller 370, and other components illustrated in FIG. 1. The network interface 12 is an example of hardware that implements the communicators 500 and 501 illustrated in FIG. 1. The main storage device 13 and the auxiliary storage device 14 are examples of hardware that implements the flag storage 330, the setting storage 310, the mode storage 380, and other components illustrated in FIG. 1.

The input device 16 receives an input of external data. The input device 16 includes, for example, a human interface device such as a mouse, a keyboard, a touchscreen, and a microphone. The input device 16 includes a unit that detects, for example, the state of buttons or keys to input information.

The input device 16 may be a reception interface that detects signals transmitted from other devices, such as a parallel bus or a serial bus.

The output device 17 is an information output device that displays various items of information to a user, and includes, for example, a liquid crystal display, a cathode-ray tube (CRT) display, or an organic electroluminescent (EL) display. The output device 17 includes, for example, a plotter or a printer that prints information in the form of, for example, text or an image. The output device 17 includes a unit that outputs information from, for example, the display or the printer.

The above I/O module 300 is used for connecting the host controller 200 to the control system 1 yet connected to the host controller 200 to start up the system. The connection procedure is described.

First, the user connects the external devices 401 and 402 to the I/O module 300. The user also connects the setting tool 101 to the I/O module 300 through the communicator 501.

For shipment, the I/O module 300 has the startup determination mode set to the startup mode. When the startup determination mode is set to the non-startup mode, the user sets the startup determination mode to the startup mode by operating the setting tool 101 or the mode switcher 340 in the I/O module 300.

The user causes the I/O module 300 to acquire the setting information by operating the setting tool 101 to provide electric power from the power supply 60 to the external devices 402 connected to the outputter 360.

The user performs the startup operation for starting up the control system 1 by, for example, testing the operation of the connected external device 401 and the connected external devices 402, and examining the signals input into the input terminals X1, X2, . . . , Xn or the signals output from the output terminals Y1, Y2, . . . , Yn with a measuring instrument.

Before the startup operation is complete, the external devices 401 and 402 can operate without the host controller 200 being connected to the I/O module 300.

After the startup operation is complete, the user may connect the host controller 200 to the I/O module 300. The user connects the host controller 200 to the communicator 500 and connects the setting tool 100 to the host controller 200. The user operates the setting tool 100 to set setting information with the host controller 200.

After the startup operation, the user may disconnect the setting tool 101 from the I/O module 300.

The user operates the setting tool 100 or the mode switcher 340 to switch the startup determination mode from the startup mode to the non-startup mode.

The user operates the setting tool 100 to set setting information with the host controller 200 and to cause the I/O module 300 to acquire the setting information.

The I/O module 300 causes the external devices 401 and 402 to operate based on the setting information provided from the host controller 200.

The I/O module 300 does not reconnect the external device 401 and the inputter 350 or the external devices 402 and the outputter 360 before and after the system startup operation. This structure shortens the time for the startup operation of the control system 1 as compared with when reconnection or connection state examination is performed between the external device 401 and the inputter 350 or the external devices 402 and the outputter 360.

A safety switch that detects an approaching obstacle and outputs an off signal to the input terminal X1 in the inputter 350 may be connected as the external device 401. This allows the startup operation to be performed safely.

The I/O controller 370 may detect, independently of the signals input into the input terminals X1, X2, . . . , Xn, a forced output command transmitted from the setting tool 101 connected to the communicator 501 and may cause each of the output terminals Y1, Y2, . . . , Yn in the outputter 360 to output a value of 1.

As described above, the control system 1 allows the output of the outputter 360 to be changeable without the host controller 200 being connected.

The I/O module 300 can output signals without the host controller 200 being connected. This allows easy and flexible scheduling of the startup operation.

The signals to be output from the outputter 360 may be, for example, light, current, or power. For the startup operation to be performed in multiple stages, the system may include a safety device that disconnects power from the power supply 60 to the drive for examination of the operations of the external devices 401 and 402.

The setting storage 310 described above stores a single piece of setting information at a time. However, the setting storage 310 may store multiple pieces of setting information. For example, the setting storage 310 may store both setting information received through the communicator 501 and setting information received through the communicator 500 from the host controller 200.

### Embodiment 2

A control system 2 according to Embodiment 2 further includes a display 601 that displays information about an input and an output, in addition to the components of the control system 1. The structure of the control system 2 is described below focusing on the differences from the control system 1.

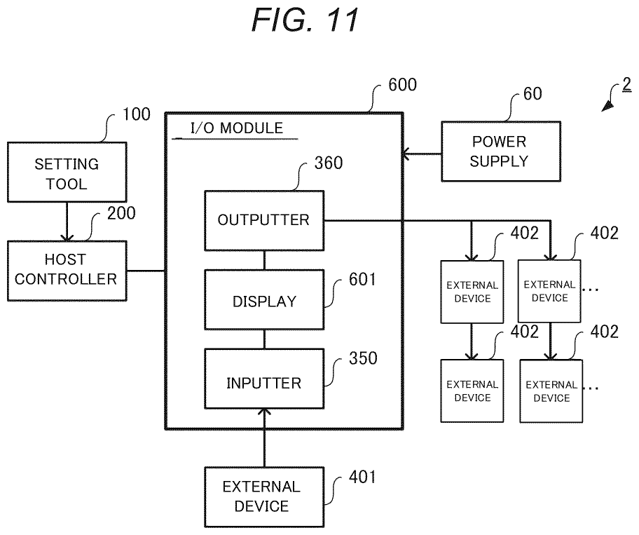

As illustrated in FIG. 11, an I/O module 600 includes the display 601 that displays information about signals being input into the inputter 350 and information about signals to be output from the outputter 360.

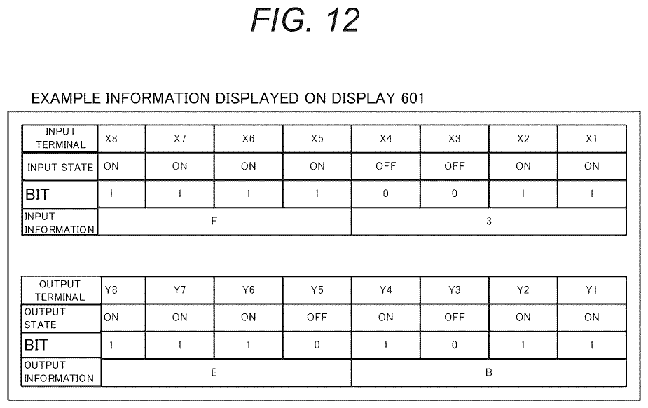

As illustrated in FIG. 12, the display 601 displays, as either ON or OFF, the input state of each of the input terminals X1, X2, . . . , X8 and the output state of each of the output terminals Y1, Y2, . . . , Y8. The display 601 uses a bit value of 1 indicating ON and a bit value of 0 indicating OFF and displays each bit value as well as bit values of 4 bits with a hexadecimal numerical value.

The control system 2 allows the user to easily view the input and the output of the I/O module 600 without directly measuring the values such as the voltage and the current of each of the input terminals X1, X2, . . . , X8 and the output terminals Y1, Y2, . . . , Y8.

Modification 1

The control systems 1 and 2 store setting information received through the communicators 500 and 501 into the setting storage 310. In some embodiments, the I/O module 300 may include a setting receiver 502 that receives the setting information.

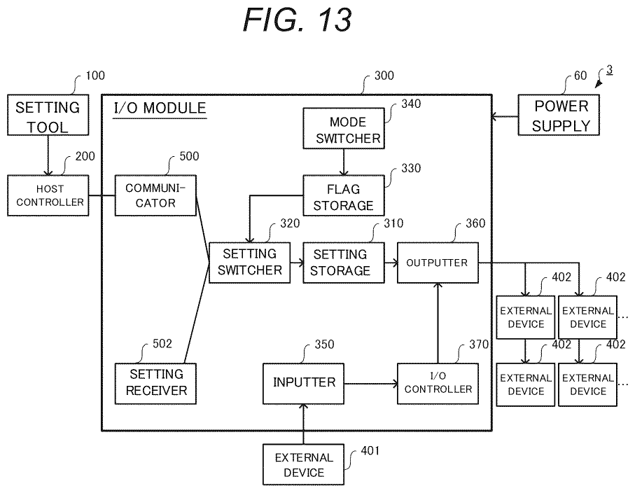

As illustrated in FIG. 13, a control system 3 according to Modification 1 includes the setting receiver 502. The control system 3 stores setting information received through the communicator 501 or setting information received by the setting receiver 502 into 310.

The setting receiver 502 is, for example, a toggle switch, a push button switch, or a DIP switch.

The user operates the setting receiver 502 to input setting information. The setting switcher 320 switches setting information between the setting information received through the communicator 500 and the setting information input into and received by the setting receiver 502. The selected setting information is thus stored into the setting storage 310.

Modification 2

The control systems 1, 2, and 3 each include the I/O module 600 including the display 601 that displays information about an input and an output. In contrast, a control system 4 according to Modification 2 causes a display tool 701 to display information about an input and an output. The structure of the control system 4 is described below focusing on the differences from the control systems 1 to 3.

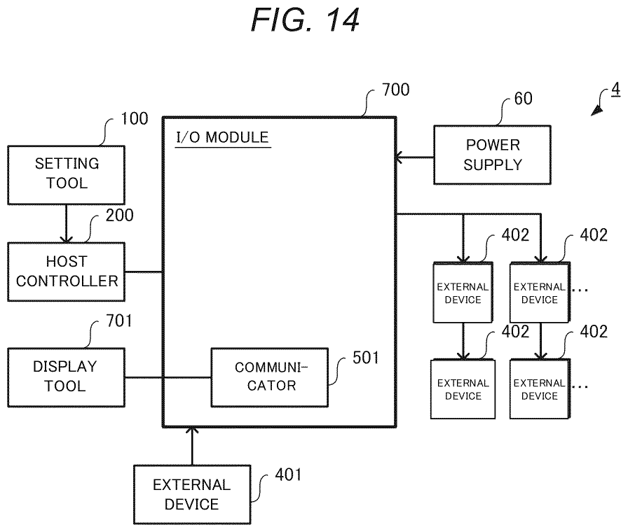

As illustrated in FIG. 14, the display tool 701 is connected to an I/O module 700 through the communicator 501. The display tool 701 displays error information that occurs during an input or an output.

The control system 4 allows the user remote from the I/O module 700 to view the display tool 701 and easily identify the cause of an error.

The method described in each of the above embodiments is implementable as a computer-executable program stored in a non-transitory storage medium, such as a magnetic disk, an optical disc, a magneto-optical disk, or a semiconductor memory, executable by various devices. A computer that implements the embodiments of the present disclosure reads a program stored in the non-transitory storage medium and performs the processes described above under control in accordance with the program.

The present disclosure is not limited to the embodiments described above and may be implemented in other embodiments with modifications as appropriate.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1, 2, 3, 4 Control system
10 Information operation device
11 Processor
12 Network interface
13 Main storage device
14 Auxiliary storage device
15 Bus
16 Input device
17 Output device
60 Power supply
100, 101 Setting tool
200 Host controller
300, 600, 700 I/O module
310 Setting storage
320 Setting switcher
330 Flag storage
340 Mode switcher
350 Inputter
360 Outputter
370 I/O controller
401, 402 External device
500, 501 Communicator
502 Setting receiver
601 Display
701 Display tool

1. An input-output module, comprising:
processing circuitry
including an input terminal to receive an input signal,
including an output terminal to output a signal,
to receive first setting information from a host controller, the first setting information being information for setting a condition of a value of the signal to be output from the output terminal or a condition between a value of the input signal received by the input terminal and a value of the signal to be output from the output terminal and being information for controlling an operation of an external device connected to the input-output module,
to receive second setting information, the second setting information being information for setting the condition of the value of the signal to be output from the output terminal or the condition between the value of the input signal received by the input terminal and the value of the signal to be output from the output terminal and being information for controlling an operation of an external device connected to the input-output module,
to store the received first setting information or the received second setting information,
to, based on the stored first setting information or the stored second setting information, cause the output terminal to output a signal with the set value or cause the output terminal to output a signal with a value in accordance with the set condition and the value of the input signal received by the input terminal, and
to switch a mode between a first mode and a second mode, wherein
when the mode is in the first mode, the processing circuitry, based on the first setting information, causes the output terminal to output the signal with the set value or causes the output terminal to output the signal with the value in accordance with the set condition and the value of the input signal received by the input terminal, and
when the mode is in the second mode and is a startup mode indicating a state of a startup operation, the processing circuitry receives the second setting information from a device other than the host controller, and, based on the second setting information, causes the output terminal to output the signal with the set value or causes the output terminal to output the signal with the value in accordance with the set condition and the value of the input signal received by the input terminal.

2. (canceled)

3. The input-output module according to claim 1, wherein
when the mode is in the second mode and the processing circuitry receives the first setting information from the host controller, the mode is switched from the second mode to the first mode.

4. The input-output module according to claim 3, wherein
when the second setting information is stored in the processing circuitry and the processing circuitry receives the first setting information from the host controller, the second setting information stored in the processing circuitry is overwritten with the first setting information.

5. The input-output module according to claim 1, wherein
the processing circuitry connects a terminal device to receive the second setting information.

6. The input-output module according to claim 1, wherein
the processing circuitry receives the second setting information being input.

7. A control system, comprising:
the input-output module according to claim 1; and
a display tool connectable to the input-output module, the display tool being configured to display the value of the input signal input from an external device into the input-output module or the value of the signal to be output from the input-output module to an external device.

8. The input-output module according to claim 1, wherein
the processing circuitry causes the output terminal to output the signal based on the second setting information before the input-output module is connected to the host controller.

9. The input-output module according to claim 3, wherein
the processing circuitry connects a terminal device to receive the second setting information.

10. The input-output module according to claim 4, wherein
the processing circuitry connects a terminal device to receive the second setting information.

11. The input-output module according to claim 3, wherein
the processing circuitry receives the second setting information being input.

12. The input-output module according to claim 4, wherein
the processing circuitry receives the second setting information being input.

13. A control system, comprising:
the input-output module according to claim 3; and
a display tool connectable to the input-output module, the display tool being configured to display the value of the input signal input from an external device into the input-output module or the value of the signal to be output from the input-output module to an external device.

14. A control system, comprising:
the input-output module according to claim 4; and
a display tool connectable to the input-output module, the display tool being configured to display the value of the input signal input from an external device into the input-output module or the value of the signal to be output from the input-output module to an external device.

15. A control system, comprising:
the input-output module according to claim 5; and
a display tool connectable to the input-output module, the display tool being configured to display the value of the input signal input from an external device into the input-output module or the value of the signal to be output from the input-output module to an external device.

16. A control system, comprising:
the input-output module according to claim 6; and
a display tool connectable to the input-output module, the display tool being configured to display the value of the input signal input from an external device into the input-output module or the value of the signal to be output from the input-output module to an external device.
